(19) United States
(12) Patent Application Publication
(10) Pub. No.: US 2017/0206309 A1
(43) Pub. Date: Jul. 20, 2017

(54) METAGENOME MAPPING

(71) Applicant: INTERNATIONAL BUSINESS MACHINES CORPORATION, ARMONK, NY (US)

(72) Inventors: Niina S. Haiminen, Valhalla, NY (US); Laxmi Parida, Mohegan Lake, NY (US)

(21) Appl. No.: 15/000,203

(22) Filed: Jan. 19, 2016

(51) Int. Cl. G06F 19/18; G06F 19/24

(52) U.S. Cl. CPC G06F 19/18; G06F 19/24

(57) ABSTRACT

Embodiments include method, systems and computer program products for metagenome mapping. Aspects include receiving a plurality of operational taxonomic unit (OTU) identifications from a sample. Aspects also include calculating rank distributions for OTU identifications, ranking OTU identifications, and retaining or discarding OTU identifications based on the rankings. Aspects also include calculating a promiscuity score for each of the operational taxonomic unit identifications, wherein the promiscuity score is a number that reflects a likelihood of a false positive. Aspects also include ranking or discarding OTU identifications based on the rankings.

### BACKGROUND

The present disclosure relates generally to metagenome mapping, and more specifically, to methods, systems and computer program products for depletion of false positives in metagenome mapping.

Metagenome mapping involves extraction and identification of all genomic sequences from environmental samples. Environmental samples, such as soil samples, food samples, or biological tissue samples can contain extremely large numbers of organisms. For example, it is estimated that the human body, which relies upon bacteria for modulation of digestive, endocrine, and immune functions, can contain up to 100 trillion organisms. In the past decade, advances in sequencing and screening technologies have increased the potential for determining the microbial composition of previously unknown samples. Further, analyzing such samples to investigate functionalities and pathways within those samples, for instance by identification of which genes are present and whether certain genes may be differentially expressed within an environment, can be possible and is increasingly of interest to modern researchers. It is desirable to determine the microbial composition of an environmental sample as quickly and as accurately as possible.

### SUMMARY

In accordance with an embodiment, a computer-implemented method for metagenome mapping is provided. The method includes receiving a plurality of metagenomics reads from a sample, the plurality of metagenomics reads including a read X. The method also includes comparing the plurality of metagenomics reads to a plurality of operational taxonomic units to form a plurality of read-operational taxonomic unit pairs. The method also includes calculating a first ranking for each of the read-operational taxonomic unit pairs, wherein the first ranking for the read-operational taxonomic unit pairs for the read X is a number 1 to N, wherein 1 represents a best match for the read X and N represents a worst match for the read X. The method also includes determining a plurality of operational taxonomic unit identifications from the sample. The method also includes calculating a rank-distribution for each of the operational taxonomic unit identifications. The method also includes assigning, based on the rank-distribution, a match rank to each of the operational taxonomic unit identifications, wherein the match rank is greater than or equal to 1. In accordance with the method, based on a determination that the match rank is greater than a rank threshold, the method includes removing the operational taxonomic unit identification; and based on a determination that the match rank is less than or equal to the rank threshold, the method includes retaining the operational taxonomic unit identification.

In accordance with another embodiment, a computer program product for metagenome mapping includes a non-transitory storage medium readable by a processing circuit and storing instructions for execution by the processing circuit for performing a method. The method includes receiving a plurality of metagenomics reads from a sample, the plurality of metagenomics reads comprising a read X. The method also includes comparing the plurality of metagenomics reads to a plurality of operational taxonomic units to form a plurality of read-operational taxonomic unit pairs. The method also includes calculating a first ranking for each of the read-operational taxonomic unit pairs, wherein the first ranking for the read-operational taxonomic unit pair for the read X is a number 1 to N, wherein 1 represents a best match for the read X and N represents a worst match for the read X. The method also includes determining a plurality of operational taxonomic unit identifications from the sample. The method also includes calculating a rank-distribution for each of the operational taxonomic unit identifications. The method also includes assigning, based on the rank-distribution, a match rank to each of the operational taxonomic unit identifications, wherein the match rank is greater than or equal to 1. In accordance with the method, based on a determination that the match rank is greater than a rank threshold, the method includes removing the operational taxonomic unit identification; and based on a determination that the match rank is less than or equal to the rank threshold, the method includes retaining the operational taxonomic unit identification.

In accordance with a further embodiment, a processing system for metagenome mapping includes a processor in communication with one or more types of memory. The processor is configured to receive a plurality of metagenomics reads from a sample, the plurality of metagenomics reads comprising a read X. The processor is also configured to compare the plurality of metagenomics reads to a plurality of operational taxonomic units to form a plurality of read-operational taxonomic unit pairs. The processor is also configured to calculate a first ranking for each of the plurality of read-operational taxonomic unit pairs, wherein the first ranking for the read-operational taxonomic unit pairs for the read X is a number 1 to N, wherein 1 represents a best match for the read X and N represents a worst match for the read X. The processor is also configured to determine a plurality of operational taxonomic unit identifications from the sample. The processor is also configured to calculate a rank-distribution for each of the operational taxonomic unit identifications. The processor is also configured to assign, based on the rank-distribution, a match rank to each of the operational taxonomic unit identifications, wherein the match rank is greater than or equal to 1. Based on a determination that the match rank is greater than a rank threshold, the processor is configured to remove the operational taxonomic unit identification. Based on a determination that the match rank is less than or equal to the rank threshold, the processor is configured to retain the operational taxonomic unit identification.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 is a block diagram illustrating one example of a processing system for practice of the teachings herein;

FIG. 2 is a flow diagram illustrating a method for metagenome mapping in accordance with an exemplary embodiment; and

FIG. 3 is a block diagram illustrating a user device for metagenome mapping in accordance with an exemplary embodiment.

### DETAILED DESCRIPTION

In accordance with exemplary embodiments of the disclosure, methods, systems and computer program products for metagenome mapping are provided. In exemplary embodiments, the system is configured to reduce false positives in metagenomics analysis while retaining all true positives in identification of Operational Taxonomic Unit (OTU) in a sample.

Metagenomics, the study of genomic species obtained directly from the environment, is a desirable area of study that can be computationally and experimentally challenging. Current methods are subject to problems of sensitivity, specificity and interpretation.

Metagenome sequencing can be performed in three stages. First, an environmental sample can be prepared. For instance, DNA from a sample can be isolated and then fragmented to obtain sequence fragments small enough for current sequencing techniques. Thereafter, sample preparation can include blunting the fragment ends and ligating adaptors to the DNA fragments, for instance, to enable substrate attachment in sequencing applications. Second, the prepared samples can be sequenced. Sequencing generally includes High Throughput Sequencing methods. Third, the sequence data can be analyzed with bioinformatics to identify and further analyze the genomic content of a sample. The reads from metagenomics samples must be mapped to their respective gene, or a species, genus, or other taxonomic entity (OTU, Operational Taxonomic Unit).

Sources of difficulty in mapping include, for example, problems with the comparative databases such as redundant candidates or inaccuracies. As a result, sequences can align with multiple OTUs in a database. In addition, many different environmental strains contain significant and extensive genetic overlap, posing challenges to proper identification. Moreover, sequence errors can be introduced during the extraction process or in other biotechnological steps. As a result, current solution pipelines yield mapping results riddled with false positives, which can represent up to 95% of a predicted OTU set.

The present disclosure provides improved methods for mapping metagenome samples. Embodiments of the disclosure can reduce false positives while retaining true positive OTU assignments in a metagenome analysis. Some embodiments of the disclosure can detect apparent high-abundance false OTUs.

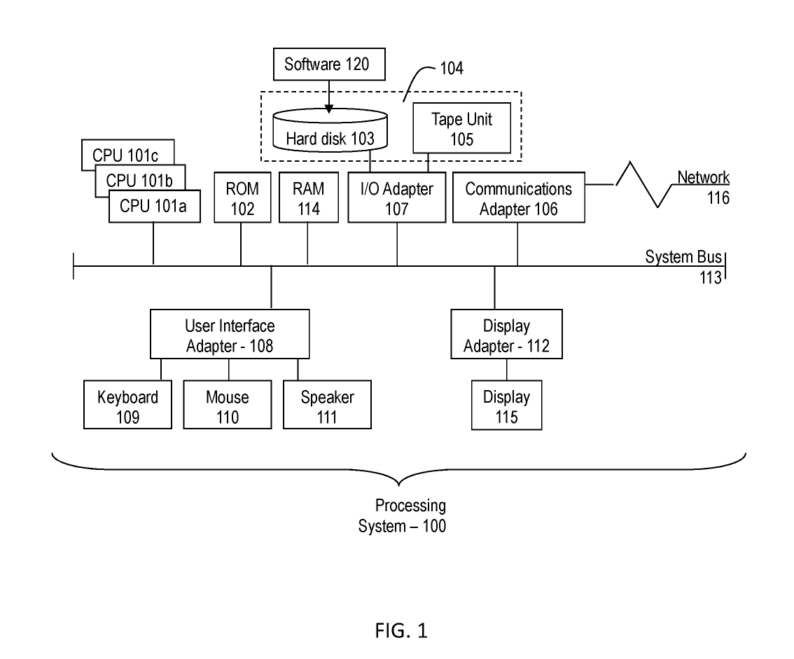

Referring to FIG. 1, there is shown an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Software 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

Thus, as configured in FIG. 1, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system such as the AIX® operating system from IBM Corporation to coordinate the functions of the various components shown in FIG. 1.

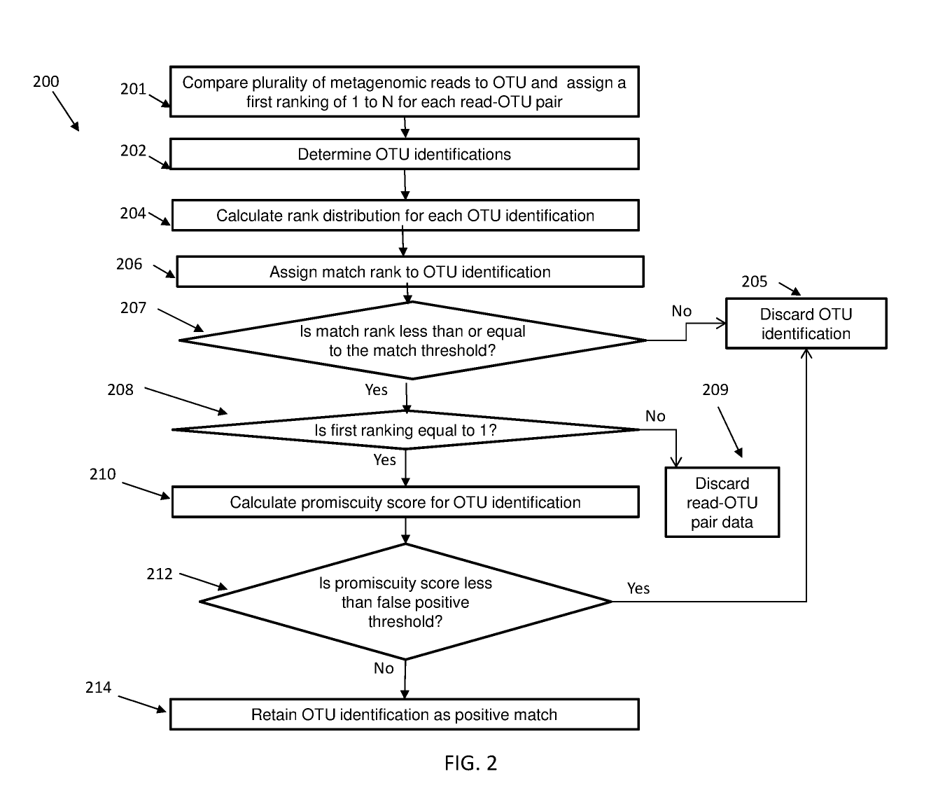

Referring now to FIG. 2, a flow chart illustrating a method 200 for metagenome mapping in accordance with an exemplary embodiment is shown. As shown at block 201, a plurality of metagenomics reads, DNA fragments sequenced according to known methods, are compared to known OTUs. Each (read,OTU) pair receives a first ranking from 1 to at most N, where OTUs with the highest sequence identity hit receive a rank of 1 and N corresponds to the total number of matches the read receives. As shown at block 202, the method 200 includes determining operational taxonomic unit (OTU) identification for each OTU with a matching read. The process can be repeated for each OTU that receives matching reads. Next, as shown at block 204, in some embodiments, the method 200 includes calculating a rank distribution curve for the OTU identifications. Then, as shown at block 206, the method includes assigning a match rank to each OTU identification. The match rank is a function of the degree to which a genomic fragment obtained from a sample matches a reference sequence in an OTU database. The match rank can be based upon the rank-distribution and can reflect, for example, the mode of distribution for the rank-distribution of each OTU.

With further reference to FIG. 2, as shown at decision block 207, the method 200 also includes determining whether a match rank is less than or equal to a match rank threshold. Match rank threshold can represent a low match rank and can be used to eliminate likely false positive OTU identifications. For example, a match rank threshold can be 1, representing only the rank 1, i.e., best matches per read are considered. In some embodiments, a rank match threshold can represent a close but not necessarily only the best match. Such an approach can be desirable, for instance, if pre-processing or biotechnology techniques are likely to introduce a number of sequence defects into a sample or if greater accuracy in retaining true positives is desired. Preferably, a rank match threshold corresponds to the best match possible in a given system. For example, where read match ranks range from 1, corresponding to the best match for that read, to 20, corresponding to the worst match, a match rank threshold of 1 or 2 can be used, preferably a match rank threshold of 1 is used. If a match rank for an OTU is greater than the match rank threshold, the method 200 includes discarding that OTU as shown at block 205. If a match rank for an OTU is less than or equal to the match threshold, the method 200 proceeds to decision block 208. As shown at decision block 208, the method the first ranking for a read OTU pair is equal to 1. If a first ranking is equal to 1, the method 200 proceeds to decision block 208. As shown at decision block 208, if the first ranking does not equal 1, the method proceeds to decision block 209 and the read-OTU pair data is discarded. If the first ranking equals 1, the method 200 can proceed to block 210.

In some embodiments, a method 200 proceeds to filter OTU identifications with a promiscuity score. In some embodiments, each read-operational taxonomic unit pair having a first ranking less than a threshold value proceeds to filter the OTU identifications with a promiscuity score. In a preferred embodiment, for each of the read-operational taxonomic unit pairs wherein the first ranking is equal to 1, a promiscuity score for each of the operational taxonomic unit identifications is determined. As shown at decision block 212, the method 200 includes determining whether the promiscuity score is less than a false positive threshold. The false positive threshold is a number above which an OTU identification has the desired likelihood of representing a true positive match. If the promiscuity score is less than the false positive threshold, the method 200 returns to block 205 and the OTU identification is discarded. If the promiscuity score is greater than the false positive threshold, the OTU identification is retained as a positive match, as shown at block 214.

In some embodiments, a method includes filtering OTU identifications with a match rank and filtering OTU identifications with a promiscuity score. In some embodiments, a method includes filtering OTU identifications with a match rank prior to or after, preferably prior to filtering OTU identifications with a promiscuity score. In some embodiments, a method includes filtering OTU identifications with a match rank without filtering OTU identifications with a promiscuity score.

The OTU identification is a preliminary identification of an operational taxonomic unit in the sample based upon comparison of a plurality of genome fragment sequences to a reference database. The OTU identification can be accomplished by known methods, and includes computationally comparing metagenome data to known DNA sequence data in existing databases such as Silva, Greengenes, NCBI, Ensembl reference genome databases and the like Computational OTU identification methods are known to persons skilled in the art and described, for example, in Derrick E Wood and Steven L Salzberg, Kraken: ultrafast metagenomics sequence classification using exact alignments, Genome Biology, Vol. 15, No. 3, 2014, R46 or Bella et al., High throughput sequencing methods and analysis for microbiome research, J. Microbiol. Methods (2013), http://dx.doi.org/10.1016/jmimet.2013.08.011. For example, and not by way of limitation, OTU identification by mapping to a reference genome can use BWA algorithms, Bowtie, BLAST, SOAPZ, or MCQ.

The rank distribution can be calculated by known methods. The mode of the rank distribution can be used to assign a match rank to each OTU identification. For each sequencing read, a match rank of 1 represents the best possible match and, in the case of a tie, i.e., two OTUs have an equal best match, the next best rank is 3. The match rank is a property of match of the metagenomic DNA to the OTU data in the reference database and reflects how closely the metagenomics DNA matches a known OTU, relative to all the other OTU matches for that DNA.

In some embodiments, a rank threshold is assigned and used to eliminate false positives prior to assigning a promiscuity score. For example, in some embodiments, a rank threshold of 2 is used. Preferably, a rank threshold of 1 is used.

In preferred embodiments, a promiscuity score is calculated for OTU identifications with a match rank of 1. The promiscuity score for a species X (promₓ) is calculated by the following formula:

$${prom}_{x} = \frac{{\sum }_{k } f ( k ) g ( {n}_{k} )}{h ( N )}$$

wherein nₖ is a number of genome fragment sequences matching the operational taxonomic unit and (k−1) other OTUs; k is an integer from 1 to the largest number of OTUs that any genome fragment matches; N is the sum of nₖ for species X. The functions f(x), g(x), h(x) are appropriate functions for determining promiscuity of an OTU identification in a sample set, for instance:

g(nₖ)=log nₖ,

h(N)=log(N+a);

f(k)=1/k².

wherein a is a constant that can be optimized to minimize the number of false positives in a sample. In the above equation, if f(x) is a decreasing function, the score penalizes the extent of promiscuity such that highly promiscuous matches receive a relatively low promiscuity score.

In the above equation, if h(x) is not a constant function, the score is disentangled from abundance.

In some embodiments, a desired false discovery rate (FDR) or receiver operator characteristic (ROC) curve can be used to assign a false positive threshold to the data. FDR can be calculated by using the following equation:

FDR=FP/(FP+TP)

wherein FP is the number of false positives and TP is the number of true positives in a sample as determined by calibration of a prior sample. For example, a threshold can be calibrated using simulated data expected to be similar to the experimental data.

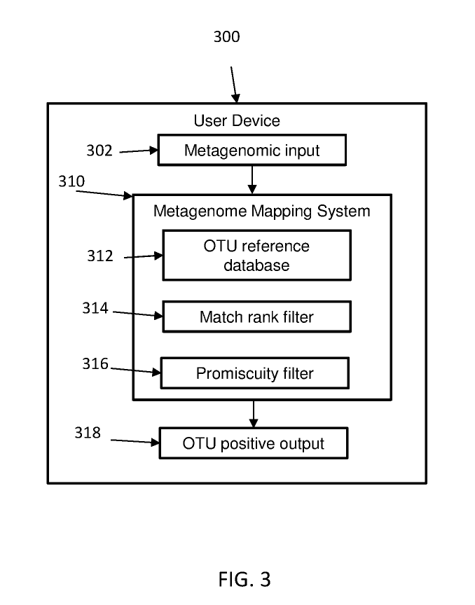

Referring now to FIG. 3, a block diagram of a user device 300 for metagenome mapping is shown. In exemplary embodiments, the user device 300 may be embodied in a smartphone, a processing system (similar to the one shown in FIG. 1), a smartwatch, or any other suitable device that includes a processor and memory. The user device 300 includes a metagenomics input interface 302. The user device also includes a metagenome mapping system 310. The metagenome mapping system can include an OTU reference database 312. OTU reference database 312 can be any database containing known partial or complete DNA sequence information for multiple OTUs. The metagenome mapping system also can include a match rank filter 314. Match rank filter 314 can determine a plurality of OTU identifications based upon comparison of fragmented genome sequences from a sample to sequences in the OTU reference database and assign a match rank to each of the OTU identifications. The match rank can be based, for example, on the mode of distribution in a rank distribution of each OTU. The metagenome mapping system 310 can also contain a promiscuity filter 316. The promiscuity filter can calculate a promiscuity score for OTU identifications. In some embodiments, the promiscuity filter can sort an OTU identification list based upon the promiscuity score. The promiscuity filter removes OTU identifications having a promiscuity score less than or equal to a false positive threshold. The user device 300 also includes an OTU positive output 318. The OTU positive output can provide OTU identifications not discarded by the match rank filter 314 or the promiscuity filter 316.

In some embodiments, the metagenome mapping system 310 eliminates all false positive OTU identifications. In some embodiments, the metagenome mapping system 310 retains all true positive OTU identifications. In preferred embodiments, the metagenome mapping system 310 eliminates all false positive OTU identifications and retains all true positive OTU identifications. In some embodiments, the OTU positive output 318 contains no false positives.

In some embodiments, the metagenome mapping system includes a match rank filter and no promiscuity filter. In some embodiments, the metagenome mapping system includes a promiscuity filter and no match rank filter. In some embodiments, the metagenome mapping system contains a match rank filter and a promiscuity filter.

The ability of the methods herein to eliminate false positives while retaining true positives was tested in a simulated experiment. Two simulated sample sets, Z1 and Z2, were provided, resulting from a bioinformatics pipeline that simulated reads from a small set of true species and matched the reads to a reference database. Sample Z1 contained 522 genus and 290 species OTU identifications, of which 13 and 7, respectively, represented true positive matches for genus and species. Sample Z2 contained 439 genus and 262 species OTU identifications, of which 13 and 7, respectively, represented true positive matches. The results are summarized in the table below.

| | | | | Output | | | |
|---|---|---|---|---|---|---|---|
| | | | | In-silico depletion | | | |
| | | | | | Promiscuity filter | | |
| | | | | | | Apply | |
| | | | | | | false | True |
| | | | | Match | | positive | Positives |
| | | Input | | rank | Lower | threshold | Lost after |
| Experiment | | pipeline | Truth | filter | bound | >0.5 | Pipeline |
| Z1 | Genus | 522 | 13 | 162 | 17 | 22 | 0 |
| | Species | 290 | 7 | 156 | 17 | 50 | 0 |
| Z2 | Genus | 439 | 13 | 174 | 17 | 27 | 0 |
| | Species | 262 | 7 | 163 | 19 | 56 | 0 |

As is shown in the above table, no true positives were lost and the OTU identifications after match rank filtration and promiscuity filtration reduced the number of false positive OTU identifications substantially.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting-data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for metagenome mapping, the method comprising:
receiving, by a processor a plurality of metagenomics reads from a sample, the plurality of metagenomics reads comprising a read X;
comparing the plurality of metagenomics reads to a plurality of operational taxonomic units to form a plurality of read-operational taxonomic unit pairs;
calculating a first ranking for each of the read-operational taxonomic unit pairs, wherein the first ranking for the read-operational taxonomic unit pairs for the read X is a number 1 to N, wherein 1 represents a best match for the read X and N represents a worst match for the read X;
determining, by a processor, a plurality of operational taxonomic unit identifications from the sample;
calculating a rank-distribution for each of the operational taxonomic unit identifications;
assigning, based on the rank-distribution, a match rank to each of the operational taxonomic unit identifications, wherein the match rank is greater than or equal to 1;
based on a determination that the match rank is greater than a rank threshold, removing the operational taxonomic unit identification; and
based on a determination that the match rank is less than or equal to the rank threshold, retaining the operational taxonomic unit identification.

2. The computer-implemented method of claim 1, further comprising calculating, by the processor, for each of the read-operational taxonomic unit pairs wherein the first ranking is equal to 1, a promiscuity score for each of the operational taxonomic unit identifications, wherein the promiscuity score is a number that reflects a likelihood of a false positive;
based on a determination that the promiscuity score is greater than a false positive threshold, retaining the operational taxonomic unit identification; and
based on a determination that the promiscuity score is less than or equal to the false positive threshold, removing the operational taxonomic unit identification.

3. The computer-implemented method of claim 1, wherein the rank threshold is 1.

4. The computer-implemented method of claim 2, wherein the operational taxonomic unit identification is a preliminary identification of an operational taxonomic unit in the sample based upon comparison of a plurality of genome fragment sequences to a reference database, and wherein the promiscuity score of an operational taxonomic unit identification X is
$$\frac{{\sum }_{k } f ( k ) g ( {n}_{k} )}{h ( N )}$$
wherein nₖ is a number of genome fragment sequences matching the operational taxonomic unit and (k−1) other OTUs; k is an integer from 1 to the largest number of OTUs that any genome fragment matches; N is a sum of nₖ and g(nₖ), h(N), and f(k) are functions suitable for determining OTU identification promiscuity.

5. The computer-implemented method of claim 4, wherein g(nₖ)=log nₖ; h(N)=log(N+a); and f(k)=1/k², wherein a is a constant.

6. The computer-implemented method of claim 2, further comprising receiving a preliminary sample identification set, wherein the false positive threshold is based upon the preliminary sample identification set.

7. The computer-implemented method of claim 2, wherein the false positive threshold is 0.5.

8. A computer program product for metagenome mapping, the computer program product comprising:
a non-transitory storage medium readable by a processing circuit and storing instructions for execution by the processing circuit for performing a method comprising:
receiving a plurality of metagenomics reads from a sample, the plurality of metagenomics reads comprising a read X;
comparing the plurality of metagenomics reads to a plurality of operational taxonomic units to form a plurality of read-operational taxonomic unit pairs;
calculating a first ranking for each of the read-operational taxonomic unit pairs, wherein the first ranking for the read-operational taxonomic unit pairs for the read X is a number 1 to N, wherein 1 represents a best match for the read X and N represents a worst match for the read X;
determining a plurality of operational taxonomic unit identifications from the sample;
calculating a rank-distribution for each of the operational taxonomic unit identifications;
assigning, based on the rank-distribution, a match rank to each of the operational taxonomic unit identifications, wherein the match rank is greater than or equal to 1;
based on a determination that the match rank is greater than a rank threshold, removing the operational taxonomic unit identification; and
based on a determination that the match rank is less than or equal to the rank threshold, retaining the operational taxonomic unit identification.

9. The computer program product of claim 8, wherein the method further comprises receiving a plurality of operational taxonomic unit identifications from a sample,
calculating, for each of the read-operational taxonomic unit pairs wherein the first ranking is equal to 1, a promiscuity score for each of the operational taxonomic unit identifications, wherein the promiscuity score reflects a likelihood of a false positive;
based on a determination that the promiscuity score is greater than a false positive threshold, retaining the operational taxonomic unit identification; and
based on a determination that the promiscuity score is less than or equal to the false positive threshold, removing the operational taxonomic unit identification.

10. The computer program product of claim 9, wherein the rank threshold is 1.

11. The computer program product of claim 10, wherein the operational taxonomic unit identification is a preliminary identification of an operational taxonomic unit in a sample based upon comparison of a plurality of genome fragment sequences to a reference database, and wherein the promiscuity score of an operational taxonomic unit identification X is
$$\frac{{\sum }_{k } f ( k ) g ( {n}_{k} )}{h ( N )}$$
wherein nₖ is a number of genome fragment sequences matching the operational taxonomic unit and (k−1) other OTUs; k is an integer from 1 to the largest number of OTUs that any genome fragment matches; N is a sum of nₖ and g(nₖ), h(N), and f(k) are functions suitable for determining OTU identification promiscuity.

12. The computer program product of claim 11, wherein g(nₖ)=log nₖ; h(N)=log(N+a); and f(k)=1/k², wherein a is a constant.

13. The computer program product of claim 9, wherein the method further comprises receiving a preliminary sample identification set, wherein the false positive threshold is based upon the preliminary sample identification set.

14. The computer program product of claim 9, wherein the false positive threshold is 0.5.

15. A processing system for metagenome mapping, comprising:
a processor in communication with one or more types of memory, the processor configured to:
receive a plurality of metagenomics reads from a sample, the plurality of metagenomics reads comprising a read X;
compare the plurality of metagenomics reads to a plurality of operational taxonomic units to form a plurality of read-operational taxonomic unit pairs;
calculate a first ranking for each of the plurality of read-operational taxonomic unit pairs, wherein the first ranking for the read-operational taxonomic unit pair for the read X is a number 1 to N, wherein 1 represents a best match for the read X and N represents a worst match for the read X;
determine a plurality of operational taxonomic unit identifications from the sample;
calculate a rank-distribution for each of the operational taxonomic unit identifications;
assign, based on the rank-distribution, a match rank to each of the operational taxonomic unit identifications, wherein the match rank is greater than or equal to 1;
based on a determination that the match rank is greater than a rank threshold, remove the operational taxonomic unit identification; and
based on a determination that the match rank is less than or equal to the rank threshold, retain the operational taxonomic unit identification.

16. The processing system of claim 15, wherein the processor is configured to:
calculate, for each of the read-operational taxonomic unit pairs wherein the first ranking is equal to 1, a promiscuity score for each of the operational taxonomic unit identifications, wherein the promiscuity score is a number that reflects a likelihood of a false positive;
based on a determination that the promiscuity score is greater than a false positive threshold, retain the operational taxonomic unit identification; and
based on a determination that the promiscuity score is less than or equal to the false positive threshold, remove the operational taxonomic unit identification.

17. The processing system of claim 15, wherein the rank threshold is 1.

18. The processing system of claim 16, wherein the operational taxonomic unit identification is a preliminary identification of an operational taxonomic unit in a sample based upon comparison of a plurality of genome fragment sequences to a reference database, and wherein the promiscuity score of an operational taxonomic unit identification X is
$$\frac{{\sum }_{k } f ( k ) g ( {n}_{k} )}{h ( N )}$$
wherein nₖ is a number of genome fragment sequences matching the operational taxonomic unit and (k−1) other OTUs; k is an integer from 1 to the largest number of OTUs that any genome fragment matches; N is a sum of nₖ and g(nₖ), h(N), and f(k) are functions suitable for determining OTU identification promiscuity.

19. The processing system of claim 18, wherein g(nₖ)=log nₖ; h(N)=log(N+a); and f(k)=1/k², wherein a is a constant.

20. The processing system of claim 16, wherein the false positive threshold is 0.5.
